(19) United States
(12) Patent Application Publication
(10) Pub. No.: US 2020/0044860 A1
(43) Pub. Date: Feb. 6, 2020

(54) SYSTEM AND METHOD FOR QUANTUM RESISTANT DIGITAL SIGNATURE

(71) Applicant: International Business Machines Corporation, Armonk, NY (US)

(72) Inventor: Wenbin ZHANG, Singapore (SG)

(21) Appl. No.: 16/051,226

(22) Filed: Jul. 31, 2018

(51) Int. Cl. H04L 9/32; H04L 9/08; H04L 9/30

(52) U.S. Cl. CPC H04L 9/3247; H04L 9/3093; H04L 9/3026; H04L 9/0852

(57) ABSTRACT

A system, method, computer program product, and service for signing a message, wherein a message to be signed is received as input data into a computer in accordance with protocols of a digital signature system. The received message is signed, using a processor on the computer implementing a trapdoor having a core polynomial map G involving three multivariate polynomial mapping functions R, T, and F as combined to form a triangle/dual-triangle composition, and a signature for the message is provided as output. One of the three multivariate polynomial mapping functions has degree 4 and two of the three multivariate polynomial mapping functions have degree 2.

### BACKGROUND

The present invention relates to quantum resistant digital signature, and more specifically, a new trapdoor design for a multivariate signature scheme in which the trapdoor has degree 4 and utilizes a new triangle/dual-triangle composition mechanism.

### SUMMARY

According to an embodiment of the present invention, a new method and system for Quantum Resistant Digital Signature is described. A key feature of this method, referred to herein as “Triangle Composition”, describes a method in which the trapdoor in Multivariate Public Key Cryptography (MPKC) has degree greater than 2 and which includes a core polynomial map G, which is defined as a composition that forms a triangle involving three polynomial maps F, T, R.

The new trapdoor includes the definition of the algorithm underlying the triangle composition construction, so that a signature can be generated for a message with a private key of this new trapdoor and the signature can be verified with the public key paired with this private key. This new method of digital signature additionally advantageously provides much smaller key size than conventional MPKC methods as well as providing potentially a strong and scalable security O(qⁿ).

### BRIEF DESCRIPTION OF THE DRAWINGS

FIG. 1 exemplarily shows in diagrammatic format the problem being addressed by the present invention;

FIG. 2 exemplarily shows a generic format generic MPKC mechanism 200;

FIG. 3 shows the core method for a first exemplary embodiment of a new trapdoor design 300 of the present invention, as used in multivariate digital signature schemes using the triangle composition mechanism;

FIG. 4 shows the core method for a second exemplary embodiment using a dual-triangle composition, wherein the roles of multivariate polynomial mapping functions R and F are reversed from their roles in the triangle composition shown in FIG. 3;

FIG. 5 shows the system design using the triangle composition scheme;

FIG. 6 shows the system design using the dual-triangle composition scheme;

FIG. 7 shows the signature generation and verification using the triangle composition scheme;

FIG. 8 shows the signature generation and verification using the dual-triangle composition scheme;

FIG. 9 exemplarily shows a comparison of public key size 902 using triangle composition and dual-triangle composition schemes;

FIG. 10 depicts a cloud computing environment according to an embodiment of the present invention; and

FIG. 11 depicts abstraction model layers according to an embodiment of the present invention.

### DETAILED DESCRIPTION

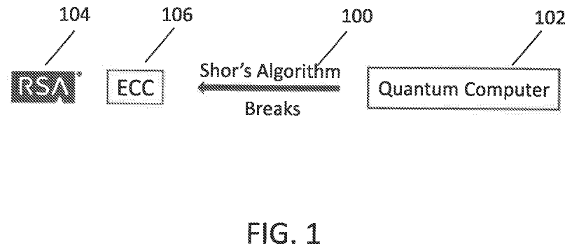

With reference now to FIG. 1, the present invention is directed to an improvement in cryptographic systems which play a fundamental role in applications such as high security business standards, such as RSA 104 or ECDSA 106, used universally on Internet transactions. Elliptic Curve Digital Signature Algorithm or ECDSA is a cryptographic algorithm used by Bitcoin to ensure that funds can only be spent by their rightful owners.

For example, with the ECDSA cryptographic system, a private key is s secret number known only to the person that generated it and is essentially a randomly generated number. Someone with the private key that corresponds to finds on the public ledger can spend the Bitcoin funds. In Bitcoin, a private key is a single unsigned 256-bit integer (i.e., 32 bytes). A public key is a number that corresponds to a private key but does not need to be kept secret. A public key can be calculated from a private key, but not vice versa. A public key can be used to determine if a signature is genuine (i.e., produced with the proper key) without requiring the private key to be divulged. In Bitcoin, public keys are either compressed or uncompressed. Compressed public keys are 33 bytes, consisting of a prefix either 0x02 or 0x03, and a 256-bit integer called v. The older uncompressed keys are 65 bytes, consisting of constant prefix (0x04), followed by two 256-bit integers called x and y (2*32 bytes), The prefix of a compressed key allows for they value to be derived from the x value.

A signature is a number that proves that a signing operation took place. A signature is mathematically generated from a hash of something to be signed, plus a private key. The signature itself is two numbers known as r and s. With the public key, a mathematical algorithm can be used on the signature to determine that it was originally produced from the hash and the private key, without needing to know the private key. Signatures are either 73, or 71 bytes long, with probabilities approximately 5%, 50% and 25% respectively, although sizes even smaller than that are possible with exponentially decreasing probability.

RSA (Rivest-Shamir-Adleman) is an acronym formed of the initials of the surnames of the three individuals who first publicly described this algorithm in 1978.

RSA is one of the first public-key cryptosystems and is still widely used for secure data transmission and digital signature as well. In such a cryptosystem, the encryption/signing key is public and differs from the decryption/verification key which is kept secret (private), thereby being an example of an asymmetric cryptography system as referring to any cryptographic system that uses pairs of keys: public keys which may be disseminated widely, and private keys which are known only to the owner.

The asymmetry of RSA is based on the practical difficulty of the factorization of the product of two large prime numbers. A user of RSA creates and then publishes a public key based on two large prime numbers, along with an auxiliary value. The prime numbers must be kept secret. Anyone can use the public key to encrypt a message (or the secret key to sign a message), but with currently published methods, and if the public key is large enough, only someone with knowledge of the prime numbers can feasibly decode the message (or forge a signature).

As further demonstrated in FIG. 1, the present invention is directed to the problem recognized in cryptography that Shor's algorithm 100, which provides a quantum algorithm (an algorithm that runs on a quantum computer) for factorization, could be used to break public-key cryptography schemes such as the RSA scheme and ECDSA. On a quantum computer 102, to factor an integer N, Shor's algorithm would run in polynomial time, meaning the time taken is polynomial in log N, which is the size of the input. Thus, using fast multiplication with a number of quantum gates of order O((log N)²(log log N)(log log log N)), the integer factorization problem can be efficiently solved on a quantum computer substantially faster than the most efficient known classical factoring algorithms. Such awareness of the potential of Shor's algorithm has facilitated research on new cryptosystems that are secure from quantum computers, often collectively called post-quantum cryptography. The cryptography community has been actively searching for such algorithms since the early 1990s, and the National Institute of Standards and Technology (NIST) in the United States called for quantum-secure cryptographic algorithms in 2017.

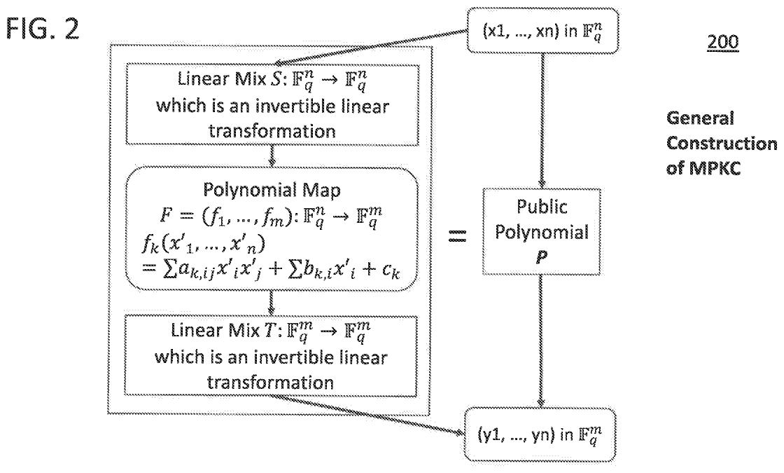

FIG. 2 shows a generic MPKC mechanism 200. Advantages of the MPKC mechanism include very short input, high efficiency, and a security foundation that is backed by an NP-hard problem. Existing designs use degree 2 polynomials, and most have failed, with the remaining designs having disadvantages including large key sizes, moderate security, and lack of theoretical proof and weak scalability. Famous examples of MPKC include, for example, UM (EUROCRYPT 1999), Rainbow (ACNS 2005), QUARTZ (CTRSA 2001), Gui (AsiaCrypt 2015). The last one Gui is considered the best scheme so far.

Advantages of Multivariate Public Key Cryptography (MPKC) for digital signature include the features of a very short signature, high efficiency, security foundation as backed by an NP-hard problem. The disadvantages of MPKC include features of a large public key size (typically at least around 60K bytes for 80-bit security) with moderate security, weak scalability and lack of theoretical proof of security. The present invention provides new digital signature schemes of degree 4 which overcomes these disadvantages based on original methods referred to herein as “Triangle Composition” and “Dual-Triangle Composition”.

For purpose of clarity in describing the present invention and as well understood in the art of cryptograph, the term “trapdoor” is related to the term “trapdoor function” and is distinguished from the term “backdoor”, as follows. A backdoor is a mechanism added to a cryptographic algorithm such as a key pair generation algorithm or digital signing algorithm or to an operation system. A backdoor permits one or more unauthorized parties to somehow bypass or subvert the security of the system.

In contrast, a trapdoor function is a function that is easy to compute in one direction but difficult to compute in the opposite direction without special information, typically referred to as the “trapdoor”. Trapdoor functions are widely used in cryptography. Thus, a trapdoor function can be described as a function ƒ: D→R, such that, given x in D,ƒ(x) in R is easy to compute, but the inverse ƒ(x)⁻¹ is difficult to compute without knowing the associated trapdoor.

Also, for purpose of this discussion, the term “degree” as used herein refers to the degree of a polynomial function and is the highest degree of its monomials (individual terms) with non-zero coefficients. The degree of a term is the sum of the exponents of the variables that appear in it, and thus is a non-negative integer. For example, the polynomial 4x²y³+5x−8, which can also be expressed as 4x²y³+5x−8x⁰ y⁰, has three terms. The first term has a degree of 5 (the sum of the powers 2 and 3), the second term has a degree of 1, and the last term has a degree of 0. Therefore, the polynomial has a degree of 5, which is the highest degree of any term.

The term “composition”, often symbolized with “∘”, is understood in the art as referring to a mechanism that combines simple functions to build a more complicated function. Similar to the composition concept in mathematics, when implemented on a computer, the result of each function is passed as the argument of the next, and the result of the last one is the result of the whole composition.

Thus, for example, the functions ƒ: X→Y and g: Y→Z can be composed to yield a function which maps x in X to g(ƒ(x)) in Z. The resulting composite function is denoted g∘ƒ: X→Z, defined by (g∘ƒ)(x)=g(ƒ(x)), for all x in X Relative to the present invention, a composition g∘ƒ involving multivariate polynomial maps g, will have degree 4, when g, ƒ each has degree 2.

Trapdoor designs of Multivariate Public Key Cryptography (MPKC) are still mainly of degree 2, with a few of degree 3. As recognized by the present inventor and as would be understood in the art, this is due to three main reasons: 1) the key size normally becomes huge when the degree is higher than 2, 2) any higher degree polynomial can be reduced to degree 2 polynomials, and 3) the obvious composition F1∘F2 has been tried in some designs but found to be insecure and there lacks nontrivial approach for such composition. However, degree 2 remains a considerable restriction on the freedom of trapdoor designs, and thus restricts potential in this direction for encryption. The present inventor has recognized that a future direction would be to consider higher degrees, but still small, such as degrees 3 or 4.

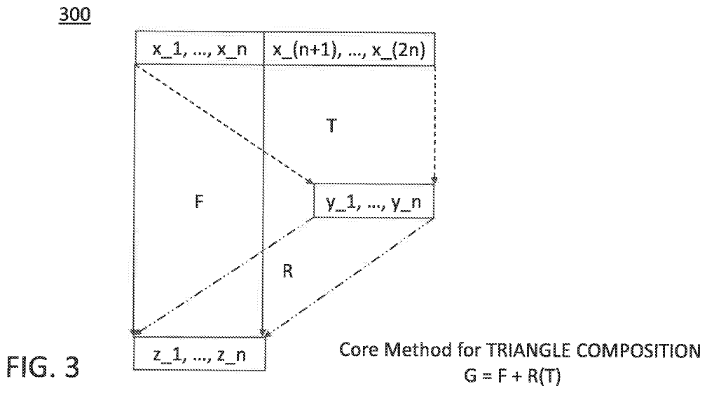

As exemplarily shown in FIG. 3, the present invention provides a new trapdoor design 300 for multivariate encryption schemes which is of degree 4 and which embeds a novel trapdoor in the composition, called the triangle composition because the composition G is a composition of map polynomials F, T, R which forms a triangle when viewed, for example, as map polynomial F providing a base and map polynomials T and R as forming the sides of the triangle when viewed from the side of the composition G.

Thus, in FIG. 3, the core polynomial map G of the triangle composition is defined: (z1, . . . , zn)=G(x1, . . . , x2n)=F(x1, . . . , xn)+R(T(x1, . . . , x2n)).

This trapdoor design 300 has the following three special properties:
It is expected that the central degree 4 polynomial map cannot be decomposed as the composite of two quadratic polynomial maps in general;
Because R is random, the part Ro T is (mostly) random as well and has no linear relationship with F∘proj;
The variables x1, . . . xn of F and the variables x1, . . . x2n of R∘T are non-linearly mixed together.

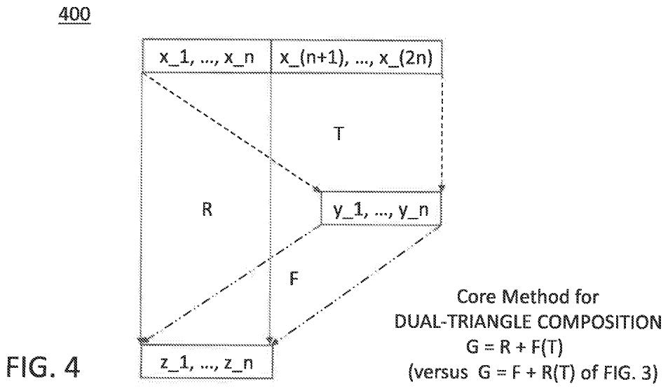

FIG. 3 shows a first exemplary embodiment of the present invention as using triangle composition G=F+R(T). FIG. 4 shows a second exemplary embodiment, referred-to herein as the dual-triangle composition wherein the roles of R and F are reversed from their roles in the triangle composition shown in FIG. 3, thereby justifying the descriptive “dual” for the composition scheme in FIG. 4. Thus, in the dual-triangle composition G=R+F(T).

Returning now to the core method of the triangle composition shown in FIG. 3, the parameters are:
xi, yi, zi are variables in [symbol] _{q} the finite field with q elements which is also often denoted as GF(q);
F(x1, . . . , xn) is an invertible multivariate polynomial map of degree 4;
T(x1, . . . , x2n) is a degree 2 multivariate map such that (xn+1, . . . , x2n) can be solved given any (x1, . . . , xn) and (y1, . . . , yn)=T(x1, . . . , x2n). This map is of a triangular/trapezoid shape, thus the notation “T”; and
R(y1, . . . , yn) is a random multivariate polynomial map of degree 2.

Define the core polynomial map G of the triangle composition in FIG. 3:

(z1, . . . ,zn)=G(x1, . . . ,x2n)=F(x1, . . . ,xn)+R(T(x1, . . . ,x2n)).

Here, the construction of G is a composition of F, T, R which form a triangle, thus the name “triangle composition”.

FIG. 4 shows a second exemplary embodiment, referred-to herein as the dual-triangle composition wherein the roles of R and F are reversed from their roles in the triangle composition shown in FIG. 3, thereby justifying the descriptive “dual” for the composition scheme in FIG. 4. The parameters of the dual-triangle composition are given below—notice that there are differences compared to the triangle composition:
xi, yi, zi are variables in [symbol] _{q};
R(y1, . . . , yn) is a random multivariate polynomial map of degree 4;
T(x1, . . . , x2n) is a degree 2 multivariate map such that (xn+1, . . . , x2n) can be solved given any (x1, . . . , xn) and (y1, . . . , yn)=T(x1, . . . , x2n);
F(x1, . . . , xn) is an invertible multivariate polynomial map of degree 2.

Define the core polynomial map G of the triangle composition in FIG. 3:

(z1, . . . ,zn)=G(x1, . . . ,x2n)=R(x1, . . . ,xn)+F(T(x1, . . . ,x2n)).

There are a few well known, big enough, classes of invertible multivariate polynomial maps which are of degree 2 and can be inverted efficiently. Any two of them can form a degree 4 map by composition, thus there are a sufficient classes of degree 4 invertible polynomials to be used for the new methods here. There are also sufficient candidates for T in MPKC to be used here.

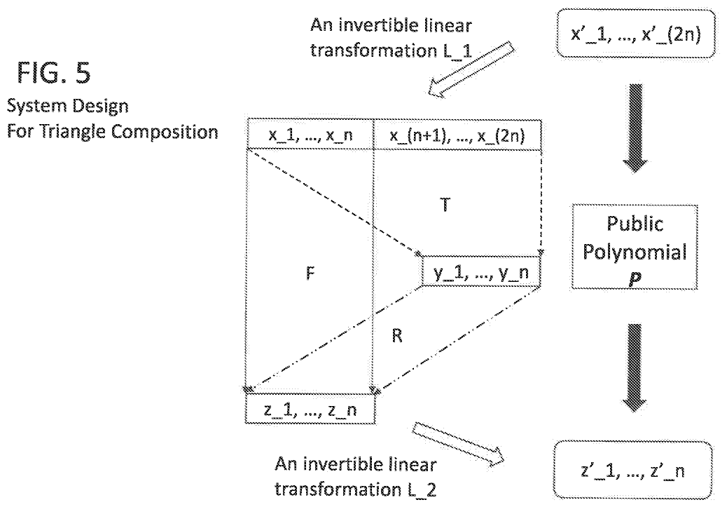

FIG. 5 shows the system design as based on the triangle composition scheme. In FIG. 5, L1 is an invertible linear transformation mapping (x′1, . . . , x′2n) to (x1, . . . , x2n) and L2 is another invertible linear transformation mapping (z1, . . . , zn) to (z′1, . . . , z′n). The private key consists of (the coefficients of) L1, L2, F, T, R, and the public polynomial map P (the public key) is defined as:

(z′1, . . . ,z′n)=P(x′1, . . . ,x′2n)=L2(G(L1(x′1, . . . ,x′2n)))=L2{F(x1, . . . ,xn)+R(T(x1, . . . ,x2n))}.

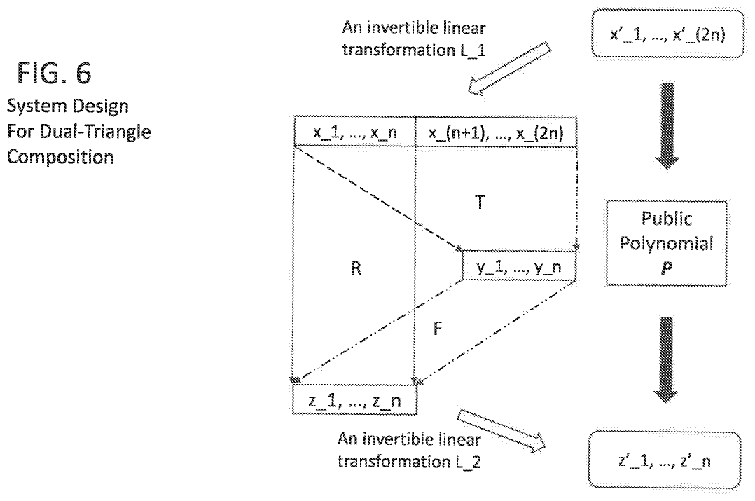

FIG. 6 shows the corresponding system design as based on the dual-triangle composition. The private key consists of (the coefficients of) L1, L2, F, T, R, and the public polynomial map P (the public key) is defined as:

(z′1, . . . ,z′n)=P(x′1, . . . ,x′2n)=L2(G(L1(x′1, . . . ,x′2n)))=L2{R(x1, . . . ,xn)+F(T(x1, . . . ,x2n))}.

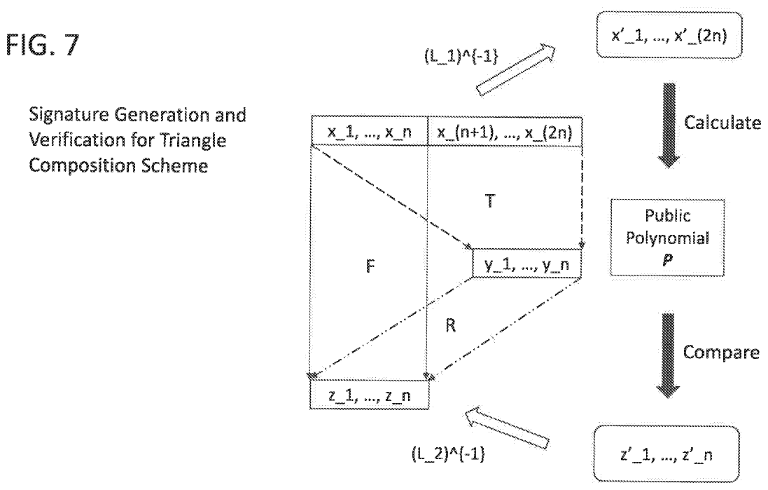

FIG. 7 shows the signature generation and verification processing using triangle composition, as follows. Given a message (z′1, . . . , z′n), a signature is generated as follows:

1. z=(z1, . . . , zn)=L2\hat{ }{−1}(z′1, . . . , z′n);

2. Randomly pick y=(y1, . . . , yn), calculate u=z−R(y);

3. Calculate (x1, . . . , xn)=F\hat{ }{−1}(u);

4. Calculate (x_{n+1}, x_{2n}) from T(x1, . . . , xn)=y; and

5. Calculate (x′1, . . . , x′2n)=L\hat{ }{−1} (x1, . . . , x2n).

To verify a signature (x′1, . . . , x′2n) using triangle composition, simply calculate P(x′1, . . . , x′2n) and check P(x′1, . . . , x′2n)=(z′1, . . . , z′n). If this equality holds, the signature is valid, otherwise invalid.

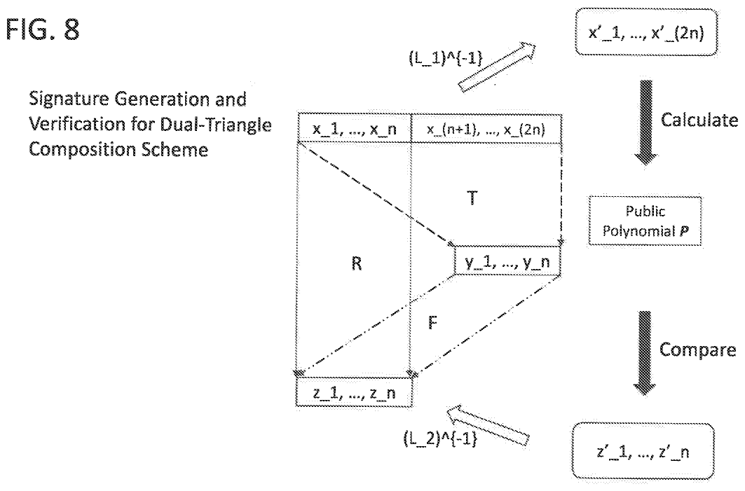

FIG. 8 shows the signature generation and verification processing using dual-triangle composition, as follows. Given a message (z′1, . . . , z′n), a signature is generated as follows:
1. z=(z1, . . . , zn)=L2\hat{ }{−1} (z′1, . . . , z′n);
2. Randomly pick x=(x1, . . . , xn), calculate u=z−R(x);
3. Calculate (y1, . . . , yn)=F\hat{ }{−1}(u);
4. Calculate (x_{n+1}, . . . , x_{2n}) from T(x1, . . . , xn)=(y1, . . . , yn); and
5. Calculate (x′1, . . . , x′2n)=L1\hat{ }{−1} (x1, . . . , x2n). (x′1, . . . , x′2n) is then a signature for the message (z′1, . . . , z′n).

To verify a signature (x′1, . . . , x′2n) using dual-triangle composition, simply calculate P (x′1, . . . , x′2n) and check P(x′1, . . . , x′2n)=(z′1, . . . , z′n). If this equality holds, the signature is valid, otherwise invalid.

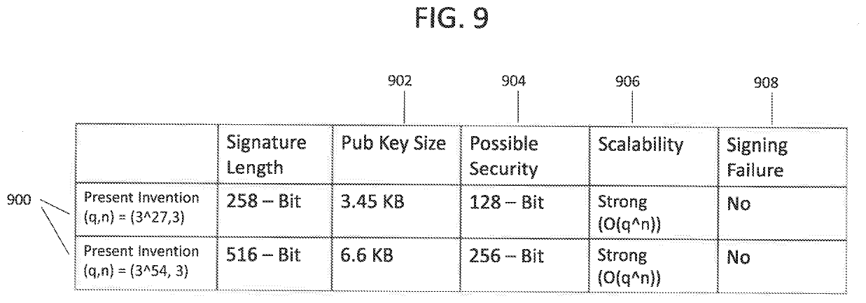

Further, as demonstrated in FIG. 9, the trapdoor mechanism of exemplary embodiments 900 of the present invention, which provide exemplary digital signature mechanisms using an original triangle/dual-triangle composition mechanism, is expected to provide a practical algorithm of degree>2 for multivariate signature schemes. That is, as shown in FIG. 9, the present invention provides a degree−4 digital signature mechanism in which the public key size 902 is much smaller than conventional methods. The triangle/dual-triangle composition mechanism also provides stronger security 904, stronger scalability 906, and no signing failure 908.

It would also to be understood by one of ordinary skill that although this disclosure includes a detailed description on cloud computing, as follows, implementation of the teachings recited herein are not limited to a cloud computing environment. Rather, embodiments of the present invention are capable of being implemented in conjunction with any other type of computing environment now known or later developed.

It would also to be understood by one of ordinary skill that although this disclosure includes a detailed description on cloud computing, as follows, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

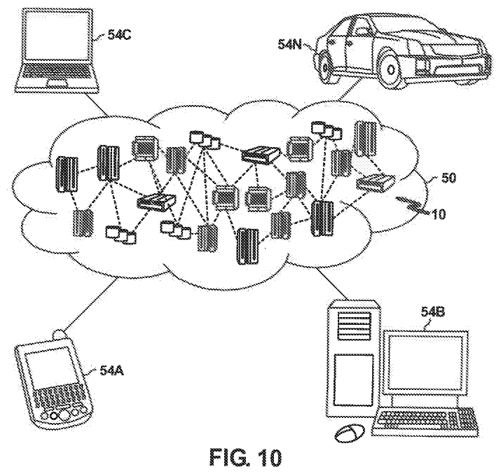

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

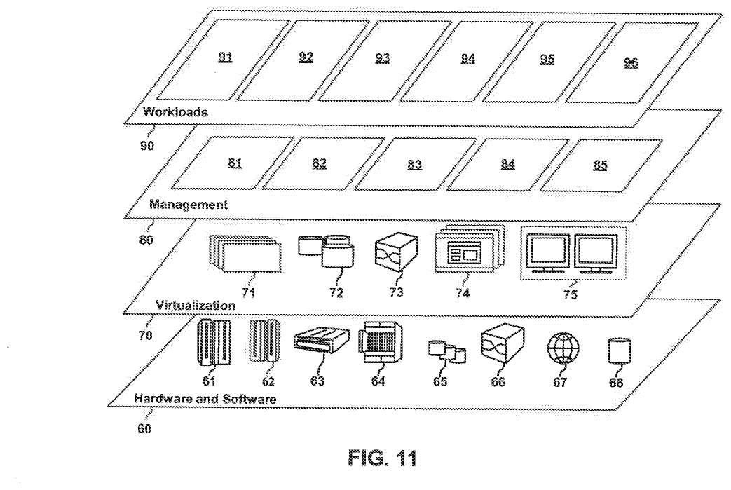

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and trapdoor 96 of the present invention, including associated functions to implement the trapdoor as described herein.

However, it should be clear to one of ordinary skill in the art that the concepts of the present invention can be implemented without using a cloud service. For example, the trapdoor and associated mechanisms of the present invention, as described herein, could be stored on a server located on the Internet such that users would access the server to receive a public key and/or transmit a plaintext message to the server for encryption, possibly using a first secure channel. The server would then encrypt the plaintext message and transmit it to a second user designated by the first user. The server would then also transmit, using a third secure channel, a private key to the second user who has received the encrypted plaintext message that was encrypted using the public key. The server would then use a third secure channel to receive from the second user the private key and the received encrypted plaintext message and would then decrypt the received encrypted plaintext message, using the private key, and then send the decrypted version of the plaintext to the second user, using a fourth secure channel.

Therefore, although the present invention is arguably based on one or more abstract concepts, the description herein clearly describes that these underlying concepts define a combination of elements that provide a solution to a technical problem in security for digital signature, thereby providing a specific solution to a real-world problem. By defining a specific method for a digital signature system based on degree 4, the claims below clearly describe more than a generic implementation of the abstract idea of a digital signature system on a generic computer. By providing a new method for digital signature based on the specific method of triangle/dual-triangle composition, the present invention utilizes these underlying concepts as defining at least one inventive concept that distinguishes from the abstract idea of digital signature. To the present inventor's knowledge, this triangle/dual-triangle composition concept has never been used in any application, let alone in a digital signature system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a message to be signed as input data into a computer in accordance with protocols of a digital signature system;
signing the message, using a processor on the computer implementing a trapdoor having a core polynomial map G involving three multivariate polynomial mapping functions R, T, and F as combined to form a triangle composition; and
outputting a signature for the message,
wherein one of the three multivariate polynomial mapping functions has degree 4 and two of the three multivariate polynomial mapping functions have degree 2.

2. The method of claim 1, wherein:
the multivariate polynomial mapping function F comprises F(x1, . . . , xn) as an invertible multivariate polynomial mapping function of degree 4,
the multivariate polynomial mapping function T comprises T(x1, . . . x2n) as a multivariate mapping function of degree 2, such that ((xn+1, . . . , x2n) can be solved given any (x1, . . . , xn) and (y1, . . . , yn): T=T(x1, . . . , x2n), and
the multivariate polynomial mapping function R comprises R(y1, . . . , yn) as a random multivariate polynomial mapping function of degree 2,
wherein the core polynomial map G is defined as:
(z1, . . . zn)=G(x1, . . . ,x2n)=F(x1, . . . ,xn)+R(T(x1, . . . ,x2n)).

3. The method of claim 2, wherein the trapdoor further comprises:
a first invertible linear transformation L1 as an input function into the trapdoor such that (x1, . . . , x2n)=L1(x′1, . . . , x′2n) given input (x′1, . . . , x′2n); and
a second invertible linear transformation L2 as an output function from the trapdoor such that output (z′1, . . . , z′n)=L2 (z1, . . . , zn),
wherein a private key of the digital signature system comprises coefficients of L1, L2, F, T, and R, and
wherein a public key of the digital signature system is defined as:
(z′1, . . . ,z′n)=P(x′1, . . . ,x′2n)=L2(G(L1(x′1, . . . ,x′2n)))=L2{F(x1, . . . ,xn)+R(T(x1, . . . ,x2n))}.

4. The method of claim 3, wherein a signature of a received message (z′1, . . . , z′n) is generated by:
1. Inputting a received message into the trapdoor by calculating z=(z1, . . . , zn)=L2−1(z′1, . . . , z′n);
2. Randomly picking y=(y1, . . . , yn) and then calculating u=z−R(y);
3. Calculating (x1, . . . , xn)=F−1(u);
4. Calculating (xn+1, . . . , x2n) from T(x1, . . . , x2n)=y; and
5. Calculating (x′1, . . . , x′2n)=L1−1 (x1, . . . , x2n) as the signature of message (z′1, . . . , z′n).

5. The method of claim 4, further comprising:
receiving a signature (x′1, . . . , x′2n);
calculating P(x′1, . . . , x′2n);
determining whether P(x′1, . . . , x′2n)=(z′1, . . . z′n); and
verifying the signature as valid when P(x′1, . . . , x′2n)=(z′1, . . . z′n).

6. The method of claim 1, wherein:
the multivariate polynomial map function of degree 4 comprises a random multivariate polynomial map function R(x1, . . . , xn),
one multivariate polynomial mapping function of degree 2 comprises multivariate polynomial mapping function T(x1, . . . , x2n) such that (x1, . . . , x2n) can be solved given any (x1, . . . , xn) and (y1, . . . , yn)=T(x1, . . . , x2n), and
the other multivariate polynomial map of degree 2 comprises an invertible multivariate polynomial map function F(y1, . . . , yn), and
wherein the triangle composition mechanism comprises a core polynomial map G:
(z1, . . . ,zn)=G(x1, . . . ,x2n)=R(x1, . . . ,xn)+F(T(x1, . . . x2n)).

7. The method of claim 6, wherein the trapdoor further comprises:
a first invertible linear transformation L1 as an input function into the trapdoor such that (x1, . . . , x2n)=L1(x′1, . . . , x′2n) given input (x′1, . . . , x′2n); and
a second invertible linear transformation L2 as an output function from the trapdoor such that output (z′1, . . . , z′n)=L2 (z1, . . . , zn),
wherein a private key of the asymmetric cryptography system comprises coefficients of L1, L2, F, T, and R, and
wherein a public key of the asymmetric cryptography system is defined:
(z′1, . . . ,z′n)=P(x′1, . . . ,x′2n)=L2(G(L1(x′1, . . . ,x′2n)))=L2{R(x1, . . . ,xn)+F(T(x1, . . . ,x2n))}.

8. The method of claim 7, wherein a signature of a received message (z′1, . . . , z′n) is generated by:
1. Inputting a received message into the trapdoor by calculating z=(z1, . . . , zn)=L2−1(z′1, . . . z′n);
2. Randomly picking x=(x1, . . . , xn) and then calculating u=z−R(x);
3. Calculating y=(y1, . . . , yn)=F−1(u);
4. Calculating (xn+1, . . . , x2n) from T(x1, . . . , x2n)=y=(y1, . . . , yn); and
5. Calculating (x′1, . . . , x′2n)=L1-1 (x1, . . . , x2n), as the signature of received message (z′1, . . . , z′n).

9. The method of claim 8, further comprising further comprising:
receiving a signature (x′1, . . . , x′2n);
calculating P(x′1, . . . , x′2n);
determining whether P(x′1, . . . , x′2n)=(z′1, . . . z′n); and
verifying the signature as valid when P(x′1, . . . , x′2n)=(z′1, . . . z′n).

10. The method of claim 1, as implemented in a cloud service.

11. A computer program product as tangibly embodied on a non-transitory memory device wherein the non-transitory memory device comprises computer-readable instructions that define a trapdoor for an asymmetric cryptography system using a triangle composition mechanism using a multivariate polynomial mapping function of degree 4 and two multivariate polynomial mapping functions each of degree 2.

12. The computer program product of claim 11, wherein:
the multivariate polynomial map function of degree 4 comprises an invertible multivariate polynomial map function F(x1, . . . , xn),
one multivariate polynomial mapping function of degree 2 comprises a multivariate polynomial mapping function T(x1, . . . , x2n) such that (x1, . . . , x2n) can be solved given any (x1, . . . , xn) and (y1, . . . , yn)=T(x1, . . . , x2n), and
the other multivariate polynomial map of degree 2 comprises a random multivariate polynomial map function R(y1, . . . , yn), and
wherein the triangle composition mechanism comprises a core polynomial map G:
(z1, . . . ,zn)=G(x1, . . . ,x2n)=F(x1, . . . ,xn)+R(T(x1, . . . x2n)).

13. The computer program product of claim 12, wherein the trapdoor further comprises:
a first invertible linear transformation L1 as an input function into the trapdoor such that (x1, . . . , x2n)=L1(x′1, . . . , x′2n) given input (x′1, . . . , x′2n); and
a second invertible linear transformation L2 as an output function from the trapdoor such that output (z′1, . . . , z′n)=L2 (z1, . . . , zn),
wherein a private key of the asymmetric cryptography system comprises coefficients of L1, L2, F, T, and R, and
wherein a public key of the asymmetric cryptography system is defined:
(z′1, . . . ,z′n)=P(x′1, . . . ,x′2n)=L2{F(x1, . . . ,xn)+R(T(x1, . . . ,x2n))}

14. The computer program product of claim 13, wherein a signature of a received message (z′1, . . . , z′n) is generated by:
1. Inputting a received message into the trapdoor by calculating z=(z1, . . . , zn)=L2−1(z′1, . . . z′n);
2. Randomly picking y=(y1, . . . , yn) and then calculating u=z−R(y);
3. Calculating (x1, . . . , xn)=F−1(u);
4. Calculating (xn+1, . . . , x2n) from T(x1, . . . , x2n)=y; and
5. Calculating (x′1, . . . , x′2n)=L1−1 x2n) as the signature of (z′1, . . . , z′n).

15. The computer program product of claim 14, further comprising further comprising:
receiving a signature (x′1, . . . , x′2n);
calculating P(x′1, . . . , x′2n);
determining whether P(x′1, . . . , x′2n)=(z′1, . . . z′n); and
verifying the signature as valid when P(x′1, . . . , x′2n)=(z′1, . . . z′n).

16. The computer program product of claim 11, wherein:
the multivariate polynomial map function of degree 4 comprises a random multivariate polynomial map function R(x1, . . . , xn),
one multivariate polynomial mapping function of degree 2 comprises multivariate polynomial mapping function T(x1, . . . , x2n) such that (x1, . . . , x2n) can be solved given any (x1, . . . , xn) and (y1, . . . , yn)=T(x1, . . . , x2n), and
the other multivariate polynomial map of degree 2 comprises an invertible multivariate polynomial map function F(y1, . . . , yn), and
wherein the triangle composition mechanism comprises a core polynomial map G:
(z1, . . . ,zn)=G(x1, . . . ,x2n)=R(x1, . . . ,xn)+F(T(x1, . . . x2n)).

17. The computer program product of claim 16, wherein the trapdoor further comprises:
a first invertible linear transformation L1 as an input function into the trapdoor such that (x1, . . . , x2n)=L1(x′1, . . . , x′2n) given input (x′1, . . . , x′2n); and
a second invertible linear transformation L2 as an output function from the trapdoor such that output (z′1, . . . , z′n)=L2 (z1, . . . , zn),
wherein a private key of the asymmetric cryptography system comprises coefficients of L1, L2, F, T, and R, and
wherein a public key of the asymmetric cryptography system is defined:
(z′1, . . . ,z′n)=P(x′1, . . . ,x′2n)=L2(G(L1(x1, . . . ,x2n)))=L2{R(x1, . . . ,xn)+F(T(x1, . . . ,x2n))}.

18. The computer program product of claim 17, wherein a signature of a received message (z′1, . . . , z′n) is generated by:
1. Inputting a received message into the trapdoor by calculating z=(z1, . . . , zn)=L2−1(z′1, . . . , z′n);
2. Randomly picking x=(x1, . . . , xn) and then calculating u=z−R(x);
3. Calculating y=(y1, . . . , yn)=F−1(u);
4. Calculating (xn+1, . . . , x2n) from T(x1, . . . , x2n)=y=(y1, . . . , yn); and
5. Calculating (x′1, . . . , x′2n)=L1−1 (x1, . . . , x2n) as the signature of received message (z′1, . . . , z′n).

19. The computer program product of claim 18, wherein the trapdoor further comprises instruction for:
receiving a signature (x′1, . . . , x′2n);
calculating P(x′1, . . . , x′2n);
determining whether P(x′1, . . . , x′2n)=(z′1, . . . z′n); and
verifying the signature as valid when P(x′1, . . . , x′2n)=(z′1, . . . z′n).

20. An apparatus, comprising:
at least one processor; and
a memory device storing instructions permitting the processor to execute a trapdoor for an asymmetric cryptography system, the trapdoor comprising instructions tangibly embodied in the memory device to:
receive a plaintext message to be signed as input data into a computer in accordance with protocols of digital signature system;
signing the message, using a processor on the computer implementing a trapdoor having a core polynomial map G involving three multivariate polynomial mapping functions R, T, and F as combined to form a triangle composition; and
output a signature for the message,
wherein one of the three multivariate polynomial mapping functions has degree 4 and two of the three multivariate polynomial mapping functions have degree 2.
